(19) United States
(12) Patent Application Publication
(10) Pub. No.: US 2005/0228709 A1
(43) Pub. Date: Oct. 13, 2005

(54) Internet-based job placement system for managing proposals for screened and pre-qualified participants

(76) Inventor: Hillel Segal, Boulder, CO (US)

Correspondence Address: PATTON BOGGS, 1660 LINCOLN ST, SUITE 2050, DENVER, CO, 80264, US

(21) Appl. No.: 11/102,925

(22) Filed: Apr. 8, 2005

Related U.S. Application Data
(60) Provisional application No. 60/560,491, filed on Apr. 8, 2004.

(51) Int. Cl. G06F 17/60

(52) U.S. Cl. 705/9

(57) ABSTRACT

The present automated job placement system uses a multi-step process, with advanced screening and pre-qualification of candidates and positions, to match qualified prospective employees with job openings. The system supports two types of participant match processes that involve prospective employers and prospective employees, each acting simultaneously. One match process involves prospective employees offering proposals for available jobs, and the second match process involves prospective employers offering proposals to prospective employees. Both types of participant match processes use similar advance screening and pre-qualification procedures, with all proposal exchanges taking place on an Internet website. In addition, this automated job placement system provides built-in deadlines for each step, with an easy-to-use proposal tracking and active proposal reminder mechanism. This unique use of deadline-contingent proposals and counter-proposals greatly enhances the likelihood that a negotiated agreement will be reached that is beneficial for both parties. The overall state-of-the-art functionality thus provided is a significant improvement over existing Internet-based job search systems.

### CROSS-REFERENCE TO RELATED APPLICATIONS

This application is related to U.S. Provisional Application Ser. No. 60/560,491 filed on 8 Apr. 2004 and claims priority to that application.

### FIELD OF THE INVENTION

This invention relates to automated job placement systems and, in particular, to a system that enables the use of a multi-step process to manage the exchange of proposals between participants using advanced screening and pre-qualification of candidates and employers. The invention allows pre-qualified prospective employees to present proposals for job openings that are offered by prospective employers, allows pre-qualified prospective employers to present proposals to job applicants, and allows both parties to dynamically negotiate a mutually agreeable employment relationship.

### PROBLEM

It is a problem in the field of Internet-based job search systems that existing systems use a single step process to simply match employee candidate descriptions with existing job position descriptions. This match process is executed without regard to pre-approval of the employee candidates and does not rely on screening criteria to distinguish between qualified employee candidates and unqualified employee candidates. Therefore, the results of the match process are often misleading and unusable because unqualified prospective job candidates are compared to qualified job prospective candidates. In addition, the existing Internet-based job search systems do not have the ability for either side to solicit and receive proposals that have specific deadlines, or to keep track of simultaneous proposals from employee candidates to employers and from employers to employee candidates. These existing systems also fail to provide any reminder functionality to indicate deadlines for responding to proposals and counter-proposals. As a result, while existing Internet-based job search systems may provide the participants with a “rough first cut” of available positions or candidates, they do not provide sufficient functionality to narrow the search to just the few best positions or candidates, nor provide a system for proposals and counter proposals that facilitate the successful conclusion of negotiations between the participants.

U.S. Pat. No. 6,662,194 discloses a system for providing recruitment information, including a memory device for storing information regarding a job opening and a processing device for processing information regarding the job search request upon a detection of an occurrence of a searching event. The processing device utilizes information regarding the job opening to generate a message in response to the job search request and transmits the message to a communication device associated with an individual in real-time.

U.S. Pat. No. 6,480,884 discloses a method for enabling users to exchange group electronic mail by establishing individual profiles and criteria for determining personalized subsets within a group. Users establish subscriptions to an electronic mailing list by specifying user profile data and acceptance criteria data to screen other users. When a user subscribes, a web server establishes and stores an individualized recipient list including each matching subscriber and their degree of one-way or mutual match with the user. When the user then sends a message to the mailing list, an email server retrieves 100% of the matches and optionally filters the recipient list down to a message distribution list using each recipient's message criteria. The message is then distributed to matching users.

U.S. Pat. No. 6,584,471 discloses a system for receiving, organizing, and displaying information received from a plurality of users, having a hierarchical database with at least one expandable level, at least one of the expandable levels having at least two expandable sublevels. An interactive interface is used for placing each user at a level and sublevel in the database, receiving user-supplied information for modification and addition to the content and structure of the levels and sublevels of the database. The user can supply commands for navigating through and extracting content from the database. The system dynamically profiles members of an on-line community in that it allows a member to see those who have answered query items in a subcategory and category in a manner suggestive of some desired similarity in character.

U.S. Pat. No. 6,418,415 discloses an aggregate conditional purchase offer management system for receiving and processing conditional purchase offers from buyers for one or more goods or services. If a received conditional purchase offer is accepted, the buyer is bound on behalf of the accepting seller. Conditional purchase offers are also administered on behalf of groups of buyers to form aggregate conditional purchase offers which are offered to sellers. Groups are preferably formed dynamically in accordance with predefined aggregation rules.

U.S. Publication No. 2002/0013735 discloses a digital system for matching desired characteristics with item attributes. The system provides for weighting of variable values to be matched, and substitution of variables or values. Both discrete and continuous weighting can be used. This approach provides for more flexible matching to yield practical and useful results without placing high requirements on the computer system. Weights can be assigned to variable values as defaults. One feature of the system allows preferences to be matched with regard to two different sides of a transaction. This allows sellers to eliminate items or services from a particular transaction based on seller goals of profitability, or where it makes a difference as to who the buyer is, or what is being offered in exchange for an item or service for sale.

U.S. Pat. No. 5,164,897 discloses an automated method for selecting personnel, which includes the step of selecting a first set of employees having qualifications matching a first job criterion from a first data file where the first data file includes a first plurality of records and each record includes a first job selection criterion, such as job titles, and a corresponding employee code. A second step comprises selecting a second plurality of employees having qualifications matching a second job criterion from a second data file which includes a second plurality of records wherein each record includes a second job selection criterion, such as industrial experience, and a corresponding employee code. In the preferred embodiment, a third selection is made from yet a third data file including records having a third job selection criterion, such as special skills, with a corresponding employee code. This results in three groups of selected records. The system then requires selecting the records of those personnel whose employee codes occur at least once in each of the three employee sets.

U.S. Pat. No. 5,862,223 discloses an expert matching system for managing communications between an expert having particular qualifications and an end user seeking a solution to an expert request. The system includes a controller having a database for storing expert qualifications. A search program, in response to an expert request, identifies experts qualified to respond to the expert request. The expert request is then transmitted to the expert, which results in an expert answer transmitted to and received by the central controller. After authentication of the expert answer, using a wide range of security levels from passwords to cryptography, the answer is forwarded to the end user.

U.S. patent application No. 2003/0158807A1 discloses a system wherein a job seeker accesses a human resource auction site from a mobile telephone and registers their personal information therein. The human resource auction site obtains the job seeker's license certificate from a corresponding license organization and publishes personal information of the job seeker to hold a human resource auction. Recruiting companies participate in the auction and each of them places an offer for a salary payable to the job seeker who matches the job requirements by the recruiting company.

Published Patent Application WO011526A1 discloses an on-line auction system, implemented on a website, which manages the entire competing-offer process for construction and home improvement projects, including the steps of receiving the job requests from homeowners and posting them on the website for viewing, receiving the offers from contractors, and processing the offer selection made by the homeowners.

Published Patent Application WO0125993A1 discloses a system for matching buyers and sellers of goods and/or services for a project. The invention enables a buyer to specify a project in terms of physical, functional, temporal, financial, and/or transactional parameters, which are then automatically converted into at least one request for goods and/or services needed to complete the project. The requests are suitably provided to at least one seller who may submit a response to the request, as desired. Additionally, the system provides a forum for the negotiation of any agreements and the formation of contracts to provide the requested, or alternative, goods and/or services.

Published Patent Application WO0146881A1 discloses a method for putting job hunting/job offers to auction over a computer network and a storage medium for storing the same therein. Job hunters and job offerers register their situation-wanted information and help-wanted information in an auction server. Further, the job hunters and job offerers register competitive offers in the auction server, respectively, on the basis of the help-wanted information and situation-wanted information. Each of the job hunters then determines a successful applicant among the job offerers on the basis of the information registered by the job offerers, and each of the job offerers determines a successful applicant among the job hunters on the basis of the competitive information registered by the job hunters. Therefore, the job hunters and job offerers can have wide opportunities to look for jobs and offer jobs, respectively.

The focus of each of the above-noted Internet-based job search systems is on a particular aspect of the traditional process of matching a job applicant with job postings, but none of these systems address either the pre-approval of job applicants or a multi-step process which operates both ways simultaneously—where jobs and employers are screened and pre-qualified for prospective employees seeking positions, and prospective employees are screened and pre-qualified for employers seeking to fill positions. Furthermore, none of these Internet-based job search systems provide a dynamic two-way proposal system where the parties can exchange proposals with other parties who have been screened and pre-approved, and none of these systems provide reminder functionality to indicate deadlines for responding to proposals and counter-proposals.

### SOLUTION

The above-described problems are solved and a technical advance achieved by the present automated job placement system which is implemented using an Internet website which incorporates a multi-step, real-time process, including advanced screening and pre-qualification of employee candidates and employers, to match qualified prospective employees with job openings. A unique aspect of the system is that the multi-step process operates both ways simultaneously—jobs and employers are criteria-screened and pre-qualified for prospective employees seeking positions, and prospective employees are skills-screened and pre-qualified for employers seeking to fill positions. Another unique aspect of this automated job placement system is that it is proposal driven, where the participants are not constrained to a simple listing, but are empowered to generate and submit proposals that embody a dynamic definition of a mutually agreeable employment relationship. This automated job placement system is also deadline driven, with a mechanism provided that allows either side to solicit and receive proposals that have specific deadlines, and which keeps track of simultaneous proposals from prospective employees to employers and from employers to prospective employees in an easy-to-use fashion. In addition, reminders are provided to the prospective employee and prospective employer to indicate the expiration times of presently active proposals. The provision of all of this functionality thereby presents a robust, real-time system that facilitates a dynamic deadline-driven exchange of information, which in turn enables the participants to truly engage each other and reach a negotiated employment agreement that is in the interests of both parties.

The automated job placement system supports two types of participant match processes that involve prospective employers and prospective employees, each acting simultaneously. Both types of participant match processes use similar procedures, with all proposal exchanges taking place via the automated job placement system Internet website. In a first type of participant match process, the criteria-screened, pre-qualified prospective employers list job openings and skills-screened, pre-qualified prospective employees transmit employment proposals for selected listings to the automated job placement system Internet website, while in the second type of participant match process (the reverse participant match processes) the skills-screened, pre-qualified prospective employees list their availability and criteria-screened, pre-qualified prospective employers transmit proposals for employment to the automated job placement system website for selection by the prospective employees. In both cases, a unique feature of this automated job placement system is the inclusion of an extensive pre-qualification procedure whereby employees and employers must first meet screening criteria in order to be able to participate in the participant match process.

In the first type of participant match process, the pre-qualification procedure entails limiting which prospective employees are able to place proposals on the automated job placement system to only those prospective employees who have been pre-approved in advance by the prospective employer (or a build-it mechanism that automates the approval of candidates based upon pre-established criteria). Without this pre-qualification step, unqualified prospective employees end up being compared against qualified prospective employees and the end result is not usable by the prospective employer. In order for a prospective employee to become pre-qualified, the person fills out a special on-line form that is directed to the prospective employer or to an employment agency or other authorized organization designated by the employer. This step allows a profile of the prospective employee to be reviewed and qualified. The qualification process may include any of a number of data gathering or confirmation steps, including but not limited to: verification of employment history, ensuring completeness of data entries on detailed skill checklists for each position, requesting additional data from the prospective employee, and the like. If the prospective employee is found to be acceptable, the prospective employer marks the record “Accepted” and the prospective employee is then notified that they have been pre-qualified and allowed to enter a proposal for the position. Furthermore, all the interactions between the prospective employees and the employers who post job openings are given specific deadlines for responses from the other side, and a mechanism is provided for each side to keep track of proposals and counter proposals in an easy-to-use fashion. In addition, reminders are provided to the prospective employee and prospective employer to indicate the expiration time of a presently active proposal.

The automatic real-time nature of this on-line process is what makes it easy to use. In addition, the prospective employer can maintain their job postings in secrecy until a pool of pre-qualified prospective employees has been located. The match process then links pre-qualified employee candidates with job postings to ensure both the accuracy of the match and the appropriateness of the selection. This process is thereby also beneficial to employment agencies where prospective employees can be screened by the employment agency and then matched to a pool of pre-qualified job postings, where the matches identify one or more job postings to prospective employees. In this case, the prospective employee need not search through job postings or request a specific job, but can be matched to a job posting that they may not even be aware of, but for which they are eminently qualified.

In the second type of participant match process, the reverse of the above, the pre-qualification procedure entails limiting which prospective employers are able to place proposals on the automated job placement system to only those prospective employers who have been pre-approved in advance by the prospective employee (or a build-it mechanism that automates the approval of employers based upon pre-established criteria). In order for a prospective employer to become pre-qualified, the prospective employee is able to view specific information provided by the prospective employer, and if the prospective employer is found to be acceptable, the prospective employee marks the record “Accepted” and the prospective employer is then notified that they have been pre-qualified and allowed to enter a proposal for the candidate. Also, as in the first type of match process, all the interactions between the parties are given specific deadlines for responses from the other side, and the mechanism is provided for each side to keep track of proposals and counter proposals in an easy-to-use fashion. In addition, reminders are provided to the prospective employee and prospective employer to indicate the expiration time of a presently active proposal.

This automated job placement system provides the parties with the ability to exchange proposals within specific built-in deadlines, after each party has been pre-approved and screened ahead of time by the other party, with an easy-to-use proposal tracking mechanism that maintains a listing of the entire set of exchanges between the participants. The use of proposals and counter-proposals enables the participants to define a mutually agreeable employment relationship. In addition, reminders are provided to the prospective employee and prospective employer to indicate the expiration time of a presently active proposal or counter-proposal, thereby providing continuing feedback to the participants regarding the present state of the negotiations.

### BRIEF DESCRIPTION OF THE DRAWINGS

FIGS. 1A through 1D illustrate, in block diagram form, the components of the present automated job placement system and a typical environment in which it operates;

FIGS. 2A and 2B illustrate, in flow diagram form, the operation of the present automated job placement system to match pre-qualified prospective employees with a job posting, where the prospective employee initiates the process for a listed position;

FIGS. 3A and 3B illustrate, in flow diagram form, the operation of the present automated job placement system to enable prospective employers to place offers for pre-qualified prospective employees, where the prospective employer initiates the process for a listed employee; and

FIGS. 4 and 5 illustrate user interface summary displays for prospective employees and prospective employers, respectively.

### DETAILED DESCRIPTION OF THE DRAWINGS

The present automated job placement system is typically implemented in an Internet environment, where the automated job placement system resides on one or more servers which are connected to the Internet and provide a user interface via a Website. The participants use their terminal equipment to connect to the Website to enter data therein and to retrieve information from the Website, as described below. Since there are numerous possible implementations of the automated job placement system and the communications environment in which it operates, one embodiment has been selected to illustrate the concept of the system and the functionality provided by this system.

The functionality of the automated job placement system extends to applications beyond the matching of prospective employees with job postings, but for the purpose of simplicity of description to illustrate the underlying architecture of the automated job placement system, the case of matching of prospective employees with job postings is used to illustrate the invention. It is expected that variations of the system architecture, the system implementation, and application of the described functions to other applications are well within the skill of those knowledgeable in this art, and would fall within the scope of the appended claims.

Participant Terminal Equipment And Communications Environment

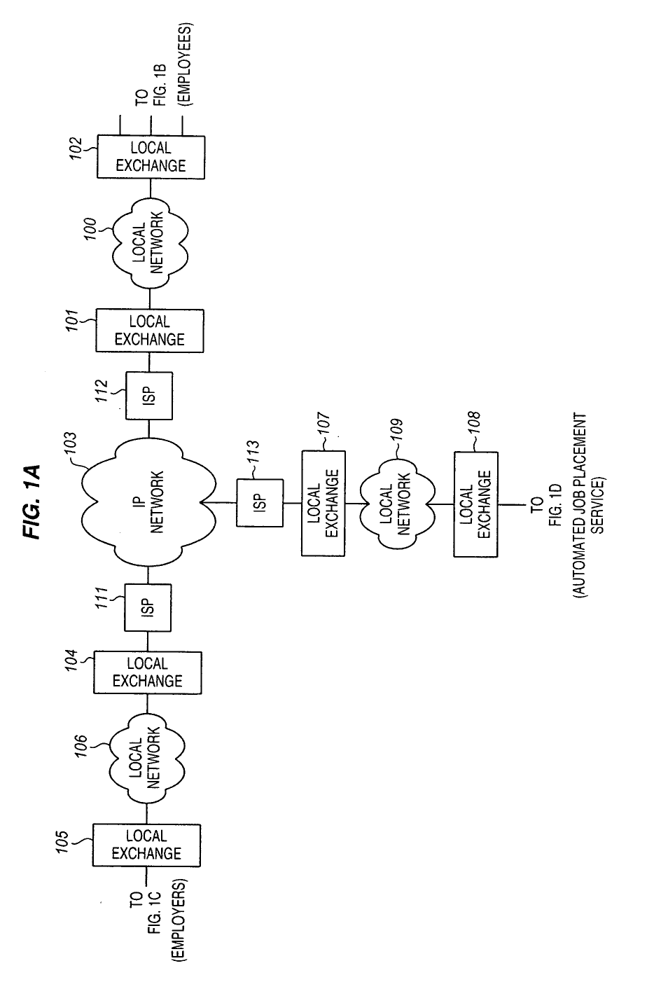

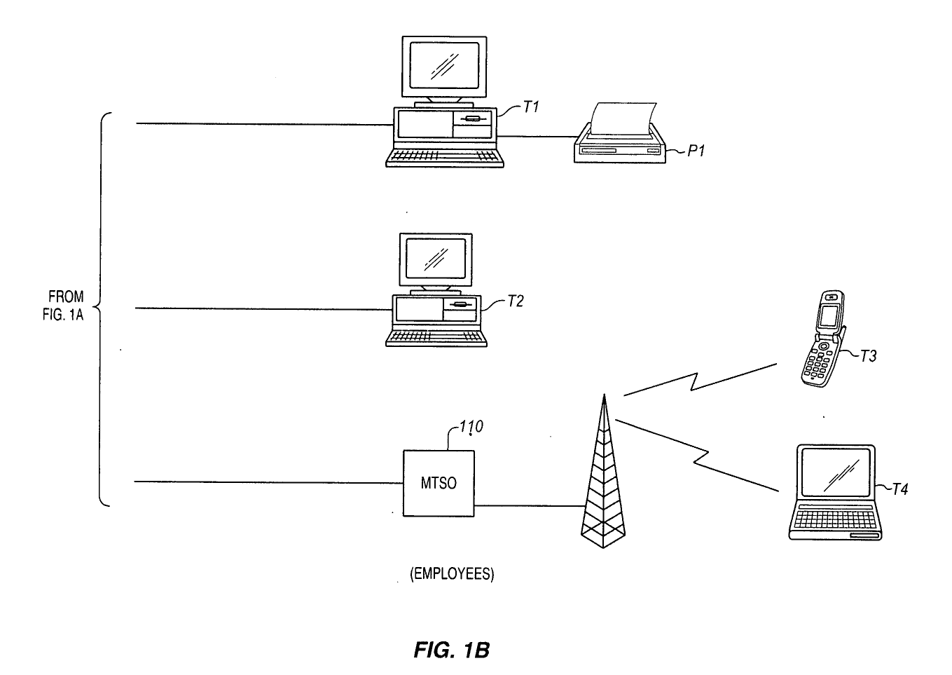

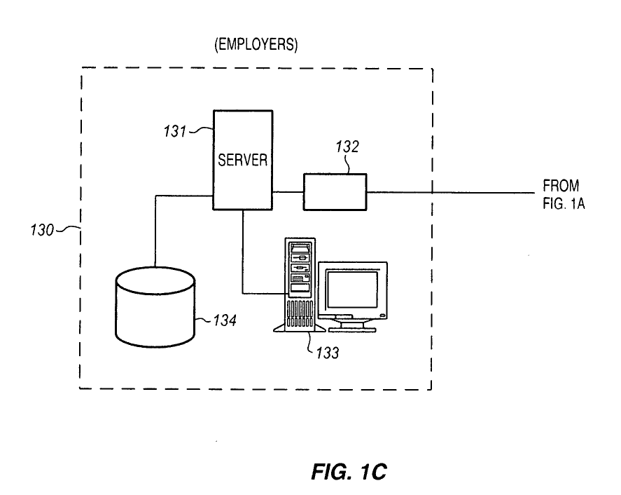

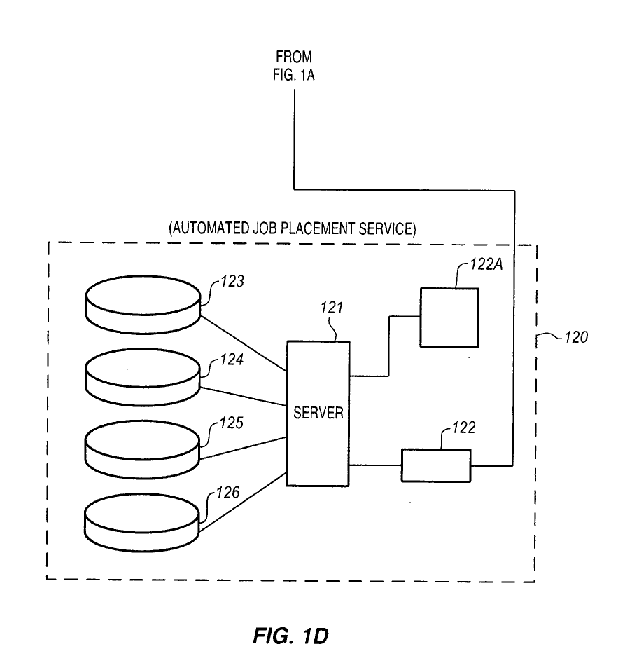

FIGS. 1A through 1D illustrate, in block diagram form, the present automated job placement system 120 and a typical environment in which it operates. The participants are typically equipped with a personal computer T1 and printer P1, or computing device T2, or cellular communication device T3, or wireless computer device T4, or other data interface device, collectively termed “terminal equipment” herein. The data communication connection between the participant's terminal equipment T1 and the automated job placement system 120 can be via a data communication medium (such as the Internet), termed IP Network 103 herein, using the well-known personal computer modem and browser technology available at the participant's terminal equipment TI. The participant's terminal equipment is generally served by the Public Switched Telephone Network (PSTN), which consists of a plurality of Local Exchange Systems 101-102, 104-105, 107-108 interconnected via an Inter-Exchange Carrier Networks 100, 106, 109, respectively. The physical connection that supports this data communication connection is typically effected from participant's terminal equipment Ti through the Local Exchange System 102 of the Public Switched Telephone Network (PSTN) to the data communication medium, IP Network 103, via an Internet Service Provider 112, which is also connected thereto. The IP Network 103 is also connected to a Local Exchange System 107 via Internet Service Provider 113, which in turn is connected via Inter-Exchange Carrier Network 109 and Local Exchange System 108 to gateway 122 of the automated job placement system 120. Alternatively, the participant's terminal equipment, in the case of cellular communication device T3, or wireless computer device T4, are connected via the Mobile Telecommunications Switching Office (MTSO) 110 to the Public Switched Telephone Network (PSTN).

The automated job placement system 120 consists of one or more software modules 122A, which reside on one or more servers 121 which are connected to the Internet and provide a user interface via a Website. The operation of these software modules 122A is described below to illustrate several of the functions that are provided by the automated job placement system 120. The automated job placement system 120 supports two types of participant match processes that involve, for example, prospective employers and prospective employees. Both types of participant match processes use similar procedures, with all exchanges of proposals taking place on an Internet website. In the first type of participant match processes, the prospective employers list job openings and prospective employees place employment proposals for selected ones of the listings on the Internet website, while in the second type of participant match processes (the reverse participant match processes) the prospective employees list their availability and prospective employers place employment proposals, directed to selected employees, on the Internet website. A unique feature of the automated job placement system is the inclusion of a pre-qualification procedure whereby employees/employers must meet pre-approval criteria to participate in the match process. The automated job placement system 120 maintains a number of databases to store the information provided by the prospective employers and prospective employees. For example, job description database 123 stores data provided by the prospective employer (typically including an employee qualification form) for use in matching prospective employees with job postings. In addition, employee database 124 stores completed employee qualification forms, while employer database 125 stores subscriber data that identifies prospective employers who are subscribers to the service provided by the automated job placement system 120. In addition, match database 126 stores data that identify matches between prospective employers and prospective employees and the proposals that are exchanged between the parties pursuant to the match. It is obvious that the data in the various databases can be linked in well-known fashion and/or that the databases can be integrated into a lesser number of databases.

The pre-qualification procedure entails limiting which prospective employees are able to place proposals on the automated job placement system 120 to only those prospective employees who have been approved by the prospective employer. Without the pre-qualification step, unqualified prospective employees end up placing proposals in competition with qualified prospective employees and the end result is not usable by the prospective employer. In order for a prospective employee to become pre-qualified, the person fills out a special on-line form that is directed to the prospective employer, employment agency, or other authorized organization by the automated job placement system 120. This step allows the pre-filed profile of the prospective employee to be reviewed and qualified. The qualification process may include any of a number of data gathering or confirmation steps, including but not limited to: verification of employment history, ensuring completeness of data entries, requesting additional data from the prospective employee, and the like. If the prospective employee is found to be acceptable for the process, the prospective employer marks the record “Accepted” and the prospective employee is then notified and allowed to enter offers.

Matching Pre-Qualified Prospective Employees With A Job Posting

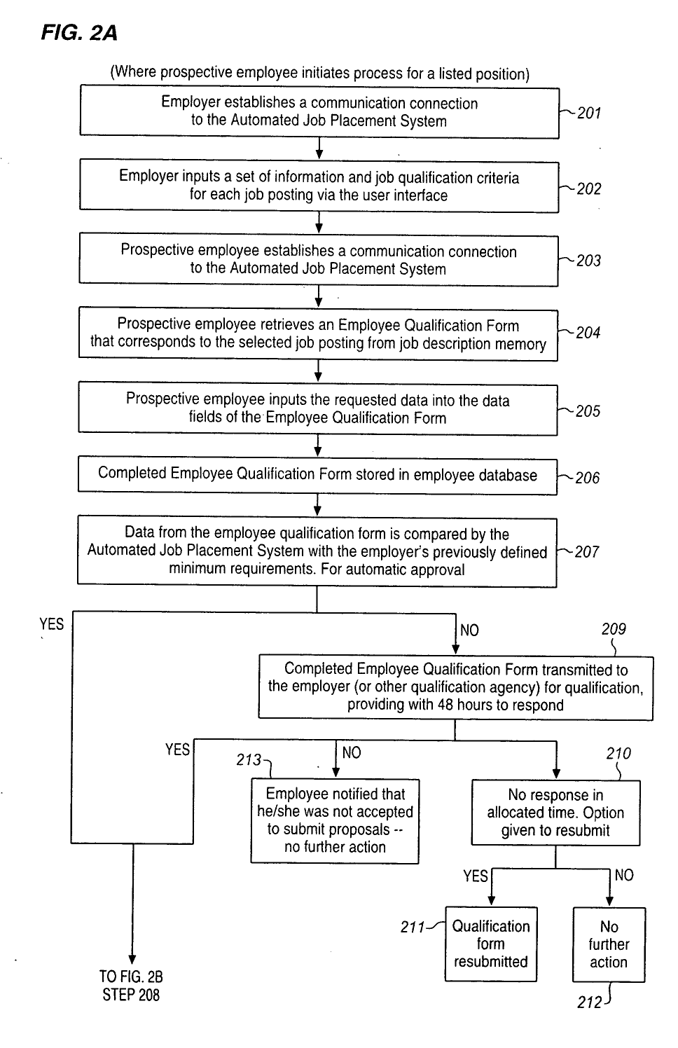

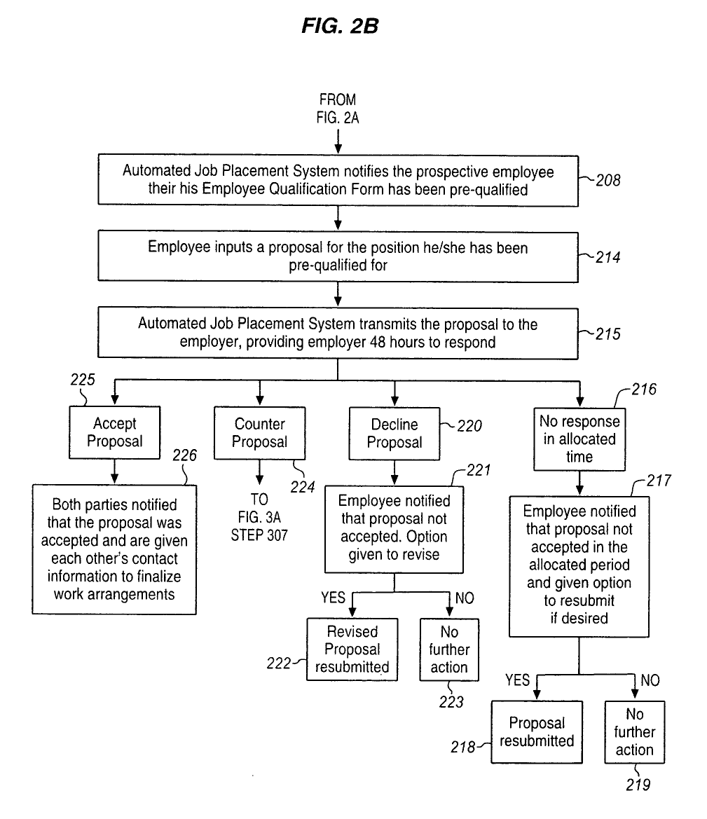

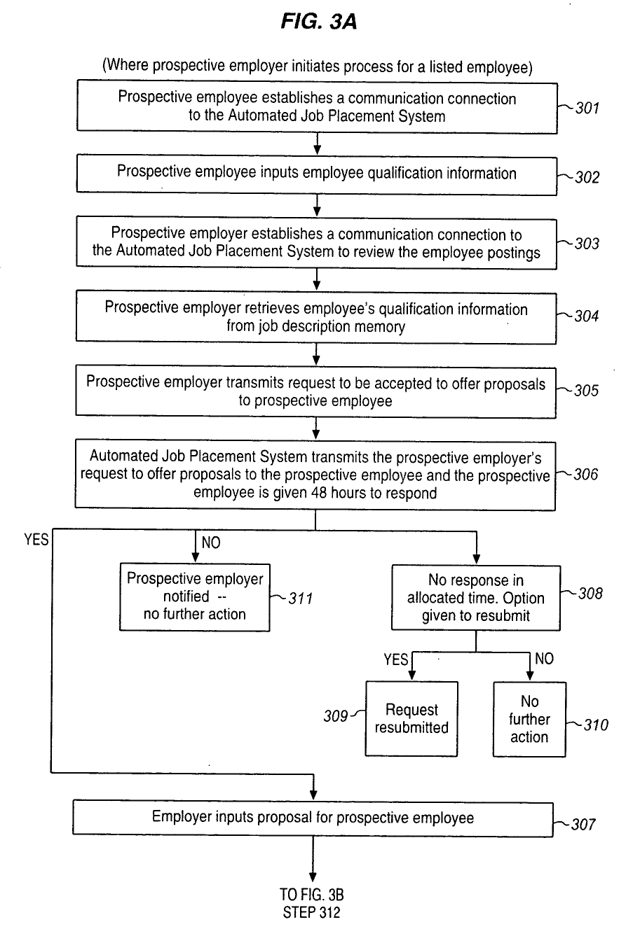

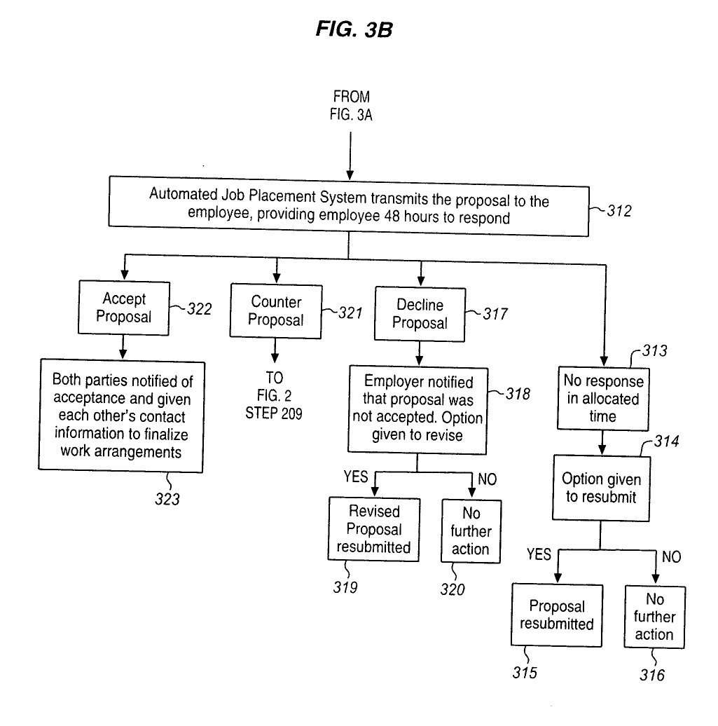

FIGS. 2A and 2B illustrate, in flow diagram form, the operation of the present automated job placement system 120 to match pre-qualified prospective employees with a job posting, where prospective employees initiate the process for a position previously listed by an employer. In this case, prospective employers list job openings and prospective employees initiate contact with the prospective employer(s) by placing proposals in the automated job placement system 120 for selected ones of the listings. What makes the entire on-line employment transaction feasible is the pre-qualification process, because this limits which prospective employees are able to place proposals to only those who have been approved by the prospective employer. Without the pre-qualification step, unqualified prospective employees end up being compared against qualified prospective employees and the end result is not usable by the prospective employer.

In step 201 in FIG. 2A, the prospective employer establishes a communication connection from their terminal equipment 133 in the employer's computer system 130 through server 131 and gateway 132 via a plurality of Local Exchange Systems 104, 105 interconnected via an Inter-Exchange Carrier Network 106 and Internet Service Provider 111 through IP Network 103 to the automated job placement system 120, as described above. The prospective employer then inputs at step 202 a set of information and job qualification criteria for each job posting via the user interface hosted by server 121. The user interface includes the appropriate login, security, and display management processes as is known in the art. This data provided by the prospective employer (typically including an employee qualification form) is stored in job description database 123 for use in matching prospective employees with the job posting.

Prospective employees can also establish a communication connection at step 203 from their terminal devices, such as terminal device T2, to the automated job placement system 120, as described above, to review the job postings that reside on the automated job placement system 120 in job description database 123. A prospective employee who wishes to enter their job qualification information into automated job placement system 120 retrieves an employee qualification form that lists the set of skills and criteria that correspond to the selected job posting from job description database 123 at step 204 and inputs the requested data into the data fields of the employee qualification form at step 205. At step 206, the completed employee qualification form is stored in employee database 124 and also transmitted to the employer (or other qualification agency) for pre-qualification.

Once the employee qualification form has been stored in employee database 124, the automated job placement system 120 links the data from the employee qualification form in employee database 124 with the job posting stored in job description database 123, at step 207. As part of this process, the automated job placement system 120 automatically evaluates the correspondence between the criteria that identify the previously defined minimum requirements associated with this job posting and qualifications of prospective employees for this job posting as stored in employee database 124. The comparison of the two sets of data (minimum requirements of the job posting, qualifications of prospective employee) uses well-known algorithms which function to compare the contents of two data sets, using appropriate rules and procedures to insure a meaningful determination of a match or the failure to match. There are numerous such processes known in the art and a description of a specific process for use in the present automated job placement system 120 is beyond the scope of this description, and is therefore not described herein.

The automated job placement system 120, upon determination of a sufficient correspondence between the two sets of data, then automatically notifies the prospective employee at step 208 that their employee qualification form has been pre-qualified, thereby providing timely feedback to the prospective employee relating to their submission of an employee qualification form.

If, at step 207, the automated job placement system 120 determines that there is an insufficient correspondence between the two sets of data, then processing advances to step 209, where the automated job placement system 120 transmits the completed employee qualification form to the prospective employer (or other qualification agency) for processing to determine whether the employer deems there to be a sufficient match to pursue further consideration of this prospective employee.

The employee qualification form can include a “skills checklist” to the employee profiles. Each job listed by the automated job placement system 120 has a skills checklist that contains specific tasks unique to that job and the form typically asks the prospective employee to rate their own experience with that task. For example, one of the 50 questions for a secretarial job may be the person's proficiency using the Microsoft Word program. The prospective employee would be asked to check one of the following levels—no experience with this program, under six months daily use of this program, six months to two years daily use of this program, more than two years of daily use of this program. The skills checklist and employee qualification form thereby allows the prospective employer to review a pre-filed profile of the prospective employee.

The data input by the prospective employee can be further authenticated by transmitting it to an authentication agency or by having the prospective employer verify the accuracy of the credentials presented by the prospective employee. The authentication of the prospective employee data can entail verification of employment history, verification of education, executing a credit check, performing a criminal background check, etc. Since these steps are laborious, it is likely that an employment screening agency can be employed to pre-qualify prospective employees who have input data into the automated job placement system 120.

The employer is provided with a time limit in which to respond to this submission (such as 48 hours) to thereby maintain a deadline driven process to ensure timely responses to the prospective employee's submission of an employee qualification form. If the employer fails to respond within the designated time, at step 210 the prospective employee is notified of the employer's inaction and is provided with the option of resubmitting the completed employee qualification form into the job applicant selection process for the posted job. If no action is taken by the prospective employee, then at step 212 the processing of this employee qualification form for this job posting is terminated. If the prospective employee requests resubmission at step 211, then the completed or amended employee qualification form is resubmitted to the employer at step 209 and the time limit for the employer's response is reset to ensure timely action by the employer on the submitted employee qualification form.

In the processing of the completed employee qualification form at step 209, if the employer rejects the form, then at step 213 the prospective employee is automatically notified by the automated job placement system 120 that they were not accepted and they are ineligible to submit proposals to the employer for this job posting. The rejection notice may include specific indications of the lack of qualifications of the prospective employee for this job posting, so the prospective employee understands the ground for the rejection of their employee qualification form. This timely feedback enables the prospective employee to search for other job postings that may be appropriate for their skill set. It is also envisioned that the automated job placement system 120 may immediately reject submitted employee qualification forms if they are so deficient that they should not be submitted to the employer, thereby rendering this process less time consuming for the employer. In that case, the automated job placement system 120 functions as the agent of the employer at steps 207, 209.

In the processing of the completed employee qualification form at step 209, if the employer accepts the form, then processing advances to step 208. Once the prospective employee's employee qualification form is accepted, either automatically by the automated job placement system 120 at step 207 or by the employer at step 209, processing advances to step 214 where the employee inputs a proposal to the automated job placement system 120 for the position for which they have been pre-qualified. At step 215, the automated job placement system 120 transmits the received employee proposal to the employer and the employer is provided with a time limit in which to respond to this submission (such as 48 hours) to ensure a timely response to the submitted proposal. If the employer fails to respond within the designated time, as determined at step 216, the employee is notified that their proposal was not acted upon within the allotted time and the prospective employee is provided with the option of resubmitting their proposal in original or amended form to the employer for this job posting at step 217. If no action is taken by the prospective employee, then at step 219 the processing of this employee proposal for this job posting is terminated. If the employee resubmits their proposal or an amended proposal to the automated job placement system 120 at step 218, then this new proposal is transmitted to the employer at step 215 as described above and the time limit for responding to this submission is reset.

In the processing of the employee proposal at step 215, if the employer declines the proposal as determined at step 220, then at step 221 the prospective employee is automatically notified by the automated job placement system 120 that their proposal was not accepted and they are eligible to submit further proposals to the employer for this job posting. The rejection notice may include specific indications for the rejection of the proposal, so the prospective employee understands the ground for the rejection of their proposal. If no action is taken by the prospective employee, then at step 223 the processing of this employee proposal for this job posting is terminated. If the employee inputs at step 222 an amended proposal to the automated job placement system 120 for the position for which they have been pre-qualified, then the automated job placement system 120 submits the newly submitted prospective employee's proposal to the employer at step 215 and the time limit for the employer's response is reset to ensure timely action by the employer on the submitted proposal.

In the processing of the employee proposal step 215, if the employer submits a counter-proposal to the prospective employee at step 224 through the automated job placement system 120, then processing advances to step 307, as described below.

In the processing of the employee proposal step 215, if the employer accepts the prospective employee's proposal at step 225, then processing advances to step 226, where the automated job placement system 120 automatically notifies both parties that the proposal was accepted by the employer and provides contact information to both parties (prospective employee and employer) to enable the parties to finalize the arrangements for the mutually agreed-upon employment relationship.

Employers Placing Offers On Pre-Qualified Prospective Employees

The reverse of the above process is where a prospective employer initiates the process for a previously listed, pre-qualified employee. FIGS. 3A and 3B illustrate, in flow diagram form, the operation of the present automated job placement system 120 to enable employers to place proposals for employment on the automated job placement system 120. In this case, prospective employees list their availability and prospective employers place employment proposals, directed to selected employees, on the Internet Website. What makes the entire on-line employment transaction feasible is the pre-qualification process, because this limits the proposals to only those prospective employers that have been approved by the prospective employee. As in the above-noted process, without the pre-qualification step, unacceptable prospective employers end up being compared against qualified prospective employers and the end result is not usable by the prospective employee. (For example, the prospective employee may pre-define and acceptable employer as one that is located within 20 miles of his or her residence, and which has a minimum of number of 50 employees.) In step 301 in FIG. 3A, the prospective employee establishes a communication connection from their terminal device T2 to the automated job placement system 120, as described above, and inputs at step 302 a set of employee qualification information via the user interface hosted by server 121. The user interface includes the appropriate login, security, and display management processes as is known in the art. This data provided by the prospective employee (typically including an employee qualification form) is stored in employee database 124 for use in matching prospective employees with job postings.

Prospective employers can also establish a communication connection at step 303 to the automated job placement system 120, as described above, to review the employee postings that reside on the automated job placement system 120 in employee database 124 or to review matches determined by the automated job placement system 120 as described above. The employer can select a prospective employee for their job posting and elect to initiate a proposal exchange process with the selected prospective employee to create an employment relationship with the selected prospective employee. A prospective employer who wishes to transmit a proposal to a selected prospective employee via the automated job placement system 120 retrieves the selected employee's employee qualification form from employee database 124 at step 304 and then transmits a request to the automated job placement system 120 at step 305 to be accepted to offer proposals to prospective employees.

The automated job placement system 120 at step 306 transmits the completed employer's request to offer proposals to the selected prospective employee and the prospective employee is provided with a time limit in which to respond to this submission (such as 48 hours) to thereby maintain a deadline driven process to ensure timely responses to the employer's submission of a request to offer proposals. If the employee fails to respond within the designated time, at step 308 the employer is notified of the prospective employee's inaction and provided with the option of resubmitting the completed employer's request to offer proposals into the process. If no action is taken, then at step 310 the processing of this employer's request to offer proposals is terminated. If the employer requests resubmission at step 309, then the employer's request to offer proposals is resubmitted to the employee at step 306 and the time limit for the employee's response is reset to ensure timely action by the employee on the submitted request to offer proposals.

In the processing of the employer's request to offer proposals at step 306, if the employee rejects the employer's request to offer proposals, then at step 311 the prospective employer is automatically notified by the automated job placement system 120 that they were not accepted and they are ineligible to submit proposals to the selected prospective employee for this job posting.

In the processing of the employer's request to offer proposals at step 306, if the employee accepts the form, then processing advances to step 312. Once the prospective employer's request to offer proposals is accepted, processing advances to step 307 where the employer inputs a proposal to the automated job placement system 120 for the position for which they have selected the pre-qualified prospective employee. At step 312, the automated job placement system 120 transmits the received employer proposal to the employee and the employee is provided with a time limit in which to respond to this submission (such as 48 hours) to thereby maintain a deadline driven process to ensure timely responses to the employer's submission of a proposal. If the employee fails to respond within the designated time, as determined at step 313, the employer is notified that their proposal was not acted upon within the allotted time and the employer is provided with the option of resubmitting their proposal in original or amended form to the employee for this job posting at step 314. If no action is taken by the employer, then at step 316 the processing of this employer proposal for this job posting is terminated. If the employer resubmits their proposal or an amended proposal to the automated job placement system 120 at step 315, then this new proposal is transmitted to the employee at step 312 as described above and the time limit for the employee's response is reset to ensure timely action by the employee on the submitted proposal.

In the processing of the employer proposal at step 312, if the employee declines the proposal, as determined at step 317, the employer is automatically notified by the automated job placement system 120 at step 318 that their proposal was not accepted and they are eligible to submit further proposals to the employee for this job posting. If no action is taken by the employer, then at step 320 the processing of this employer proposal for this job posting is terminated. If the employer inputs at step 319 a proposal to the automated job placement system 120 for the position for which they have been pre-qualified, then the automated job placement system 120 submits the newly submitted employer's proposal to the employer at step 312 and the time limit for the employee's response is reset to ensure timely action by the employee on the submitted proposal.

In the processing of the employer proposal step 312, if the employee submits a counter-proposal to the employer through the automated job placement system 120 as determined at step 321, then processing advances to step 214. In the processing of the employee proposal step 312, if the employee accepts the employer's proposal as determined at step 322, then processing advances to step 323, where the automated job placement system 120 automatically notifies both parties that the proposal was accepted by the employee and provides contact information to both parties (prospective employee and employer) to enable the parties to finalize the arrangements for the mutually agreed-upon employment relationship.

User Interface For Participants

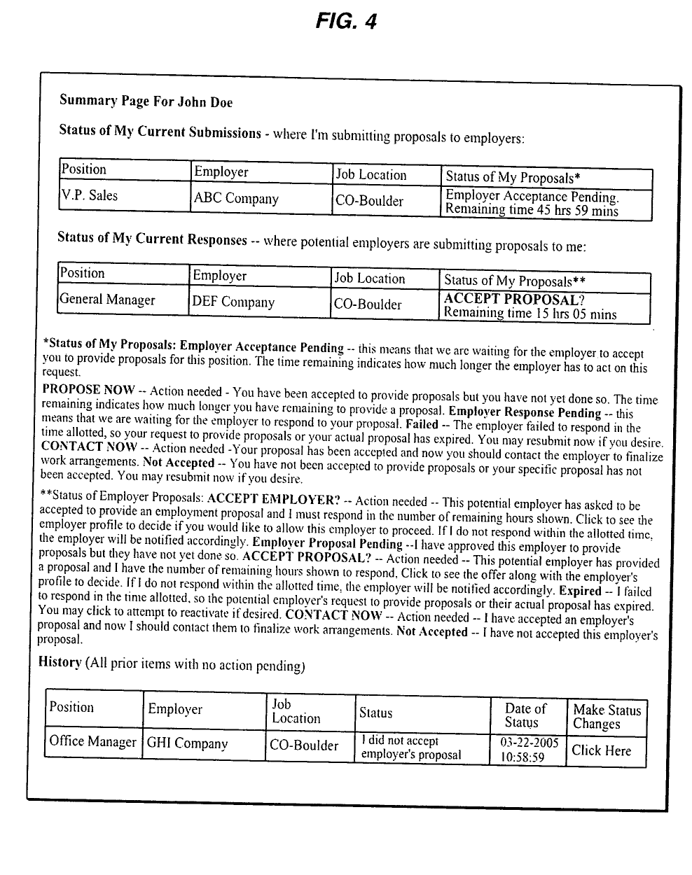

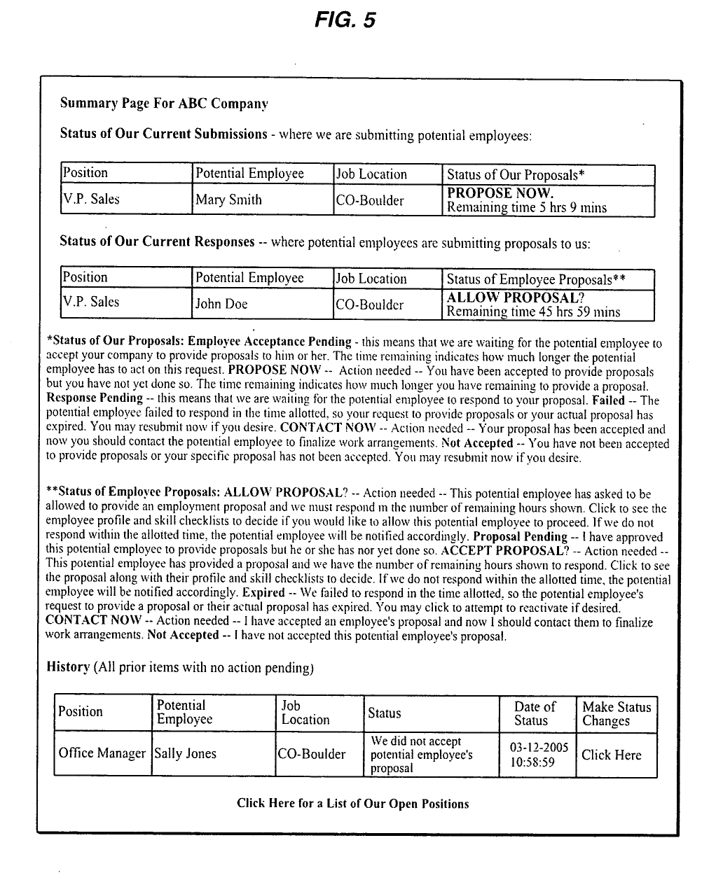

FIGS. 4 and 5 illustrate user interface displays for prospective employees and prospective employers, respectively, which track the interactions between the participants on a unique summary page. As can be seen from FIGS. 4 and 5, the summary pages provide a listing of currently active proposals and responses.

These provide data regarding the position listed in the job posting, the identity of the employer, job location, and present status of the latest outstanding proposal. The participant can sort the data, accept a presently pending proposal, or reject a presently pending proposal. Furthermore, the participant may view the detail of any item on the summary page by placing an on-screen cursor on the item and clicking the pointing device (the underlying technology for this is well-known and widely used, and is not part of this patent application.) An important characteristic of these summary pages is the real-time nature of the data, with the process being deadline driven. Therefore, the status of the participant's proposal(s) (Current Submissions) is listed along with the deadline reminder for a response to these presently active proposal(s) as well as the status of the proposal(s) received by the participant (Current Responses) along with the deadline reminder for a response to these presently active proposal(s). Therefore, this summary page presents the participants with an easily managed set of data that enables them to have an active, dynamic role in the negotiations with the other party, using a self-explanatory easily-managed interface. The summary pages also list the History, which provides data noting all prior proposals and counter proposals that have no action pending, in order to provide the participant with a listing of all exchanges to date. Using this paradigm, each of the participants have a significant amount of functionality available to them to use in the exchange of proposals, and the use of deadline-driven proposals and counter-proposals greatly enhances the likelihood that a negotiated agreement will be reached that is beneficial to both parties.

### SUMMARY

The present automated job placement system uses a multi-step process, including advanced screening and pre-qualification of candidates and/or positions, to match prospective employees with job openings. This unique automated job placement system supports two types of participant match processes that involve prospective employers and prospective employees, one matching candidates with potential employers and the other matching jobs with potential employees. Both types of participant match processes use similar pre-approval and screening procedures, with reminder functionality to indicate deadlines for responding to proposals and counter-proposals, and with all offers and counter-offers taking place on an Internet website. This unique use of deadline-contingent proposals and counter-proposals greatly enhances the likelihood that a negotiated agreement will be reached that is beneficial for both parties. The overall state-of-the-art functionality thus provided is a significant improvement over existing Internet-based job search systems.

1. An automated job placement system connected to a communication medium for automatically matching participants who provide respective sets of information and criteria, comprising:
job posting means for receiving a set of information over said communication medium from a prospective employer that defines a job posting and a set of criteria that identify qualifications of prospective employees for said job posting;
prospective employee means for receiving information over said communication medium from at least one prospective employee that identifies qualifications of at least one prospective employee;
pre-qualification means for enabling the review of said information received from a prospective employee that identifies qualifications of said prospective employee to approve said prospective employee as qualified to place employment proposals for a selected job posting; and
match means for automatically matching at least one approved prospective employee with said job posting.

2. The automated job placement system for automatically matching participants of claim 1 wherein said job posting means comprises:
skills checklist means for presenting said prospective employee with a list of specific tasks unique to said job posting.

3. The automated job placement system for automatically matching participants of claim 2 wherein said pre-qualification means comprises:
skills verification means for automatically correlating data input by said prospective employee over said communication medium in response to said list of specific tasks unique to said job posting with said set of criteria that identify qualifications of prospective employees for said job posting to generate a match when said data input by said prospective employee satisfies said set of criteria.

4. The automated job placement system for automatically matching participants of claim 3 wherein said pre-qualification means comprises:
positive feedback means for automatically notifying said prospective employee when said data input by said prospective employee in response to said list of specific tasks unique to said job posting is approved as indicating that said prospective employee is qualified to place offers on said job posting.

5. The automated job placement system for automatically matching participants of claim 3 wherein said pre-qualification means comprises:
negative feedback means for automatically notifying said prospective employee when said information received from said prospective employee is declined as indicating that said prospective employee is unqualified to place an employment proposal for said job posting.

6. The automated job placement system for automatically matching participants of claim 3 wherein said pre-qualification means comprises:
employer skills verification means for submitting data, input by said prospective employee, to said employer when said data input by said prospective employee fails to satisfy said set of criteria.

7. The automated job placement system for automatically matching participants of claim 6 wherein said pre-qualification means comprises:
positive feedback means for automatically notifying said prospective employee when said data input by said prospective employee in response to said list of specific tasks unique to said job posting is approved by said employer as indicating that said prospective employee is qualified to place offers on said job posting.

8. The automated job placement system for automatically matching participants of claim 6 wherein said pre-qualification means comprises:
negative feedback means for automatically notifying said prospective employee when said information received from said prospective employee is declined as indicating that said prospective employee is unqualified to place an employment proposal for said job posting.

9. The automated job placement system for automatically matching participants of claim 1 wherein said pre-qualification means comprises:
automated feedback means for automatically notifying said prospective employee when said information received from said prospective employee is approved as indicating that said prospective employee is qualified to place an employment proposal for said job posting.

10. The automated job placement system for automatically matching participants of claim 1 further comprising:
participant proposal means for receiving an employment proposal from a prospective employee for a one of said job postings; and
proposal delivery means for automatically delivering said received employment proposal to said prospective employer who submitted said one of said job postings.

11. The automated job placement system for automatically matching participants of claim 10 further comprising:
interaction means for exchanging proposals between said prospective employee for a one of said job postings and said prospective employer who submitted said one of said job postings.

12. The automated job placement system for automatically matching participants of claim 11 further comprising:
tracking means for maintaining a record of said proposals exchanged between said prospective employee for a one of said job postings and said prospective employer who submitted said one of said job postings.

13. The automated job placement system for automatically matching participants of claim 12 further comprising:
deadline means for maintaining a record of a deadline indicative of an expiration of a presently active proposal.

14. The automated job placement system for automatically matching participants of claim 13 further comprising:
reminder means, responsive to said deadline means, for presenting said prospective employee for a one of said job postings and said prospective employer who submitted said one of said job postings with an indication of said deadline.

15. The automated job placement system for automatically matching participants of claim 12 further comprising:
summary means, responsive to said tracking means, for displaying a record of said proposals exchanged between said prospective employee and said prospective employer to at least one of said prospective employee and said prospective employer.

16. The automated job placement system for automatically matching participants of claim 15 further comprising:
display management means, responsive to input received from at least one of said prospective employee and said prospective employer concurrent with said summary means displaying said record of said proposals, for enabling said at least one of said prospective employee and said prospective employer to modify the display of said record of said proposals to present information in a form requested by said at least one of said prospective employee and said prospective employer.

17. A method for automatically matching participants who provide respective sets of information and criteria, using an automated job placement system that is connected to a communication medium, comprising:
receiving a set of information over said communication medium from a prospective employer that defines a job posting and a set of criteria that identify qualifications of prospective employees for said job posting;
receiving information over said communication medium from a prospective employee that identifies qualifications of said prospective employee; enabling the review of said information received from said prospective employee that identifies qualifications of said prospective employee to approve said prospective employee as qualified to place employment proposals for a selected job posting; and
automatically matching at least one prospective employee with said job posting.

18. The method for automatically matching participants of claim 17 wherein said step of receiving a set of information from a prospective employer comprises:
presenting said prospective employee with a list of specific tasks unique to said job posting.

19. The method for automatically matching participants of claim 18 wherein said step of enabling comprises:
correlating data input by said prospective employee over said communication medium in response to said list of specific tasks unique to said job posting with said set of criteria that identify qualifications of prospective employees for said job posting.

20. The method for automatically matching participants of claim 19 wherein said step of enabling comprises:
automatically notifying said prospective employee when said data input by said prospective employee in response to said list of specific tasks unique to said job posting is approved as indicating that said prospective employee is qualified to place offers on said job posting.

21. The method for automatically matching participants of claim 19 wherein said step of enabling comprises:
automatically notifying said prospective employee when said information received from said prospective employee is declined as indicating that said prospective employee is unqualified to place an employment proposal for said job posting.

22. The method for automatically matching participants of claim 19 wherein said step of enabling comprises:
submitting data, input by said prospective employee, to said employer when said data input by said prospective employee fails to satisfy said set of criteria.

23. The method for automatically matching participants of claim 22 wherein said step of enabling comprises:
automatically notifying said prospective employee when said data input by said prospective employee in response to said list of specific tasks unique to said job posting is approved by said employer as indicating that said prospective employee is qualified to place offers on said job posting.

24. The method for automatically matching participants of claim 22 wherein said step of enabling comprises:
automatically notifying said prospective employee when said information received from said prospective employee is declined as indicating that said prospective employee is unqualified to place an employment proposal for said job posting.

25. The method for automatically matching participants of claim 17 wherein said step of enabling comprises:
automatically notifying said prospective employee when said information received from said prospective employee is approved as indicating that said prospective employee is qualified to place an employment proposal for said job posting.

26. The method for automatically matching participants of claim 17 further comprising:
receiving an employment proposal from a prospective employee for a one of said job postings; and
automatically delivering said received employment proposal to said prospective employer who submitted said one of said job postings.

27. The method for automatically matching participants of claim 26 further comprising:
exchanging proposals between said prospective employee for a one of said job postings and said prospective employer who submitted said one of said job postings.

28. The method for automatically matching participants of claim 27 further comprising:
maintaining a record of said proposals exchanged between said prospective employee for a one of said job postings and said prospective employer who submitted said one of said job postings.

29. The method for automatically matching participants of claim 28 further comprising:
maintaining a record of a deadline indicative of an expiration of a presently active proposal.

30. The method for automatically matching participants of claim 29 further comprising:
presenting, in response to said deadline, said prospective employee for a one of said job postings and said prospective employer who submitted said one of said job postings with an indication of said deadline.

31. The method for automatically matching participants of claim 28 further comprising:
summary means, responsive to said tracking means, for displaying a record of said proposals exchanged between said prospective employee and said prospective employer to at least one of said prospective employee and said prospective employer.

32. The method for automatically matching participants of claim 31 further comprising:
display management means, responsive to input received from at least one of said prospective employee and said prospective employer concurrent with said summary means displaying said record of said proposals, for enabling said at least one of said prospective employee and said prospective employer to modify the display of said record of said proposals to present information in a form requested by said at least one of said prospective employee and said prospective employer.

33. An automated match system for automatically matching participants who provide respective sets of information and criteria to a computer system that is connected to a communication medium, comprising:
posting means for receiving a set of information over said communication medium from an offerer participant that defines a posting comprising a proposal and a set of criteria that identify qualifications of prospective participants for this proposal;
participant means for receiving information over said communication medium from at least one party that identifies qualifications of at least one other proposing party;
pre-qualification means for enabling the review of said information received from said proposing participant that identifies qualifications of said proposing participant to approve said proposing participant as qualified to place a proposal; and
match means for automatically matching a proposing participant with said posting.

34. The automated match system for automatically matching participants of claim 33 wherein said posting means comprises:
checklist means for presenting said proposing participant with a list of specific criteria unique to said posting.

35. The automated match system for automatically matching participants of claim 34 wherein said pre-qualification means comprises:
verification means for correlating data input over said communication medium by said proposing participant in response to said list of specific criteria unique to said posting with said set of criteria that identify qualifications of prospective proposals.

36. The automated match system for automatically matching participants of claim 35 wherein said pre-qualification means comprises:
positive feedback means for automatically notifying said proposing participant when said data input by said proposing participant in response to said list of specific tasks unique to said posting is approved as indicating that said proposing participant is qualified to place offers on said posting; and
negative feedback means for automatically notifying said proposing participant when said information received from said proposing participant is declined as indicating that said proposing participant is unqualified to place a proposal for said posting.

37. The automated match system for automatically matching participants of claim 35 wherein said pre-qualification means comprises:
proposing participant skills verification means for submitting data, input by said proposing participant, to said offerer participant when said data input by said proposing participant fails to satisfy said set of criteria;
positive feedback means for automatically notifying said proposing participant when said data input by said proposing participant in response to said list of specific tasks unique to said posting is approved by said offerer participant as indicating that said proposing participant is qualified to place offers on said posting; and
negative feedback means for automatically notifying said proposing participant when said information received from said proposing participant is declined as indicating that said proposing participant is unqualified to place a proposal for said posting.

38. The automated match system for automatically matching participants of claim 33 wherein said pre-qualification means comprises:
automated feedback means for automatically notifying said proposing participant when said information received from said proposing participant is approved as indicating that said proposing participant is qualified to place a proposal for said posting.

39. The automated match system for automatically matching participants of claim 33 further comprising:
participant proposal means for receiving a proposal from a proposing participant for a one of said postings;
proposal delivery means for automatically delivering said received proposal to said proposing participant who submitted said one of said postings;
interaction means for exchanging proposals between said proposing participant for a one of said postings and said offerer participant who submitted said one of said postings.

40. The automated match system for automatically matching participants of claim 39 further comprising:
tracking means for maintaining a record of said proposals exchanged between said proposing participant for a one of said postings and said offerer participant who submitted said one of said postings.

41. The automated match system for automatically matching participants of claim 40 further comprising:
deadline means for maintaining a record of a deadline indicative of an expiration of a presently active proposal; and
reminder means, responsive to said deadline means, for presenting said proposing participant for a one of said postings and said offerer participant who submitted said one of said postings with an indication of said deadline.

42. The automated match system for automatically matching participants of claim 40 further comprising:
summary means, responsive to said tracking means, for displaying a record of said proposals exchanged between said offerer participant and said proposing participant to at least one of said proposing participant and said offerer participant.

43. The automated match system for automatically matching participants of claim 42 further comprising:
display management means, responsive to input received from at least one of said offerer participant and said proposing participant concurrent with said summary means displaying said record of said proposals, for enabling said at least one of said offerer participant and said proposing participant to modify the display of said record of said proposals to present information in a form requested by said at least one of said offerer participant and said proposing participant.
